(19) United States
(12) Patent Application Publication
(10) Pub. No.: US 2019/0137838 A1
(43) Pub. Date: May 9, 2019

(54) COATING PROCESS USING PREMIXED PRINT FORMULATIONS

(71) Applicant: BASF SE, Ludwigshafen am Rhein (DE)

(72) Inventors: Michael Goebel, Neustadt (Weinstr.) (DE); Maraike Ahlf, Ludwigshafen (DE); Fabian Seeler, Ludwigshafen (DE); Jens Roeder, Ludwigshafen (DE)

(21) Appl. No.: 16/082,057

(22) PCT Filed: Mar. 7, 2017
(86) PCT No.: PCT/EP2017/055320

§ 371 Date: Sep. 4, 2018

(30) Foreign Application Priority Data
Mar. 7, 2016 (EP) 16159032.8

(51) Int. Cl. G02F 1/1524; G02F 1/1523; G02F 1/155; G02F 1/1516

(52) U.S. Cl. CPC G02F 1/1524; G02F 1/1525; G02F 2001/1536; G02F 1/15165; G02F 1/155

(57) ABSTRACT

Described are a process for preparing a layer structure for an electrochromic device and a process for preparing an electrochromic device.

The present invention relates to a process for preparing a layer structure for an electrochromic device and to a process for preparing an electrochromic device.

Electrochromic materials are characterized by an ability to change their optical properties, reversibly, and persistently, when a voltage is applied across them (see Claes G. Granqvist, Solar Energy Materials & Solar Cells 99 (2012) 1-13). This ability is herein also referred to as the “electrochromic effect”. A change of the optical absorption of the electrochromic material occurs when electrons are transferred to or away from the electrochromic material, along with charge balancing ions entering from an adjacent electrolyte.

Certain electrochromic materials have the property of exhibiting a change, evocation, or bleaching of color (in the visible range of the electromagnetic spectrum) as effected either by an electron-transfer (redox) process or by a sufficient electrochemical potential (see Mortimer, R. J.: “Electrochromic materials”, Annu. Rev. Mater. Res. 2011. 41:241-68). However, as used herein, the term “electrochromic material” is not limited to materials exhibiting a change, evocation, or bleaching of color (in the visible range of the electromagnetic spectrum). Thus, materials changing their optical absorption, e.g. in the UV or IR range of the electromagnetic spectrum without a visible color change, are herein also referred to as “electrochromic”.

The term “electrochromic device” as used herein refers to a device exploiting the effect of electrochromism. Such device comprises at least one electrode comprising an electrochromic material, a counter electrode and an ion conductive separator layer disposed between and electronically separating said electrodes. A widely known type of electrochromic devices are so-called smart windows. The term “smart windows” is known in the art.

Related art is also US 2010/039690 A1, US 2002/086909 A1 and US 2014/043667 A1.

U.S. Pat. No. 8,593,714 B2 discloses an electrochromic device comprising a pair of electrodes separated by an electrolyte layer, wherein one of said electrodes comprises an electrochromic material, an ion-conductive binder and conductive nanowires, and said electrode is deposited by a printing process. More specifically, said electrode comprises particles which are electrochromic and are bound together with a binder which is generally ion conductive. This electrode also has a network of electronically conductive nanowires. Since nanowires are thin, they are optically transparent. The electrochromic particles in said electrode may be large particles, or nanoparticles and may be of any shape. These particles may be rod like, spherical, disc like, cubes, etc.

U.S. Pat. No. 8,593,714 B2 does not provide detailed information regarding the manufacturing of an electrode comprising an electrochromic material, an ion-conductive binder and conductive nanowires, although this is not a trivial issue, at least due to the large number of different constituents (electrochromic material, nanowires, binder, ion conductor) which have to interact in such electrode in order to fulfill different functions (electrochromism, electronic conduction, ionic conduction, matrix-building). The large number of different constituents may cause problems with regard to their chemical compatibility. Furthermore, in order to allow expedient manufacturing of such electrodes by printing or other wet processing technique, a composition (also referred to as ink) is needed wherein the non-soluble constituents of the electrochromic composite layer (particles of electrochromic material and electronically conductive nanowires) are suspended, beside those constituents which are in the dissolved state. It is well known that suspensions of nanoobjects have limited stability because suspended nanoobjects tend to agglomerate.

Thus, it is an object of the present invention to mitigate at least some of these drawbacks of the state of the art. In particular, it is an aim of the present invention to provide a process for efficiently preparing layer structures for electrochromic devices.

The process according to the present invention includes wet-processing steps. This is considered a significant advantage, as it enables manufacturing electrochromic composite layers of electrochromic device by simple technologies applicable to large areas and continuous processing.

A process for preparing a layer structure for an electrochromic device according to a first aspect of the present invention comprises preparing an electrochromic composite layer disposed on a surface of a solid substrate,

wherein preparing said electrochromic composite layer comprises the steps of
providing a first suspension comprising nanoobjects, said nanoobjects comprising one or more electrochromic metal oxides, dispersed in a first carrier liquid having a boiling point below 120° C.
providing a second suspension comprising electronically conductive nanoobjects dispersed in a second carrier liquid having a boiling point below 120° C., said electronically conductive nanoobjects not comprising metal oxides
adding together said first suspension and said second suspension to obtain a third suspension comprising said nanoobjects comprising one or more electrochromic metal oxides and said electronically conductive nanoobjects (as defined above) dispersed in a carrier liquid having a boiling point below 120° C. consisting of said first liquid and said second liquid
forming an ink by admixing to said third suspension
   one or more kinds of polymerisable monomers,
   optionally one or more initiators for initiating radical polymerization of said one or more kinds of polymerisable monomers
   at least one electrolyte having cations selected from the group consisting of H⁺, Li⁺, Na⁺, K⁺ wherein said electrolyte comprises at least one anion which is different from OH⁻ or at least one cation from the group consisting of Li⁺, Na⁺ and K⁺
   a solvent capable of dissolving said electrolytes, wherein said solvent has a boiling point of 120° C. or higher
forming on said surface of said solid substrate a wet film by applying the formed ink to said surface of said solid substrate
removing said carrier liquid having a boiling point below 120° C. from the wet film formed on said surface of said solid substrate
polymerizing the polymerizable monomers on said surface of said solid substrate.

The term electrochromic composite layer generally denotes a layer of an electrochromic device or of a layer structure for manufacturing an electrochromic device wherein said layer comprises discrete objects comprising electrochromic materials dispersed within a continuous phase (matrix) extending throughout said layer. Both, an electronically conductive network and an ionically conductive network extend throughout the electrochromic composite layer providing for the transport of electrons and ions to and away from the dispersed objects comprising electrochromic materials when a voltage is applied. Further constituents may be dispersed in the matrix, each fulfilling specific functions and interacting with the other constituents.

An electrochromic composite layer prepared as described above comprises
a matrix formed of one or more organic polymers and
dispersed within said matrix:
   nanoobjects comprising one or more electrochromic metal oxides (hereinbelow also referred to as “metal oxide nanoobjects”)
   electronically conductive nanoobjects wherein said electronically conductive nanoobjects do not comprise metal oxides
   at least one electrolyte having cations selected from the group consisting of H⁺, Li⁺, Na⁺, and K⁺ dissolved in a solvent having a boiling point of 120° C. or higher, wherein said electrolyte comprises at least one anion which is different from OH⁻ or at least one cation from the group consisting of Li⁺, Na⁺ and K.

The electrochromic composite layer comprises a matrix formed of one or more organic polymers (hereinbelow also referred to as “organic polymer matrix”). The term “polymers” as used herein includes co-polymers (polymers obtained by co-polymerization of two or more kinds of co-polymerizable monomers). Preferably, said organic polymers forming said matrix are copolymerisation products of monomers selected from the group consisting of alkyl (meth)acrylates (first kind of copolymerizable monomer) and monomers selected from the group of hydroxyalkyl (meth)acrylates (second kind of copolymerizable monomer. As used herein, the term (meth)acrylates in each case includes acrylates and methacrylates.

Within the electrochromic composite layer, the matrix provides mechanical integrity and stability and binds and accommodates the above-defined constituents of the electrochromic composite layer which are dispersed within said matrix. Without being bound to theory, it is believed that the electronically conductive nanoobjects dispersed within the matrix form a network extending throughout the electrochromic composite layer providing for the transport of electrons to and away from the metal oxide nanoobjects when an external electric voltage is applied to the electrochromic device.

The term “electrolyte” denotes a substance which is capable of dissociating into mobile ions. When dissolved in said solvent having a boiling point of 120° C. or higher, the electrolyte is at least partly dissociated into mobile ions, thus providing for ionic conductivity in the electrochromic composite layer. Without being bound to theory, it is believed that in the electrochromic composite layer said solvent including said dissolved electrolyte (as defined above) is confined within pores extending through the matrix, thus providing a network for the transport of charge-balancing ions to and away from the metal oxide nanoobjects when an electric voltage is applied to the electrochromic device.

Said electrochromic composite layer has a thickness in the range of from 0.05 μto 500 μm, preferably of from 0.05 μm to 50 μm, most preferably of from 1 μm to 30 μm. Thickness may be determined by profilometry, atomic force microscopy or electron microscopy.

For further details of the electrochromic composite layer, reference is made to the non-prepublished patent applications having the application numbers EP16155242 and PCT/EP2017/052648. The content of said patent applications is incorporated herein by reference.

In the above-defined process according to the first aspect of the present invention, a first suspension comprising nanoobjects comprising one or more electrochromic metal oxides dispersed in a first carrier liquid having a boiling point below 120° C. and a second suspension comprising electronically conductive nanoobjects (which do not comprise metal oxides) dispersed in a second carrier liquid having a boiling point below 120° C., are provided. These first and second suspension are starting materials for forming an ink which is suitable for preparing an electrochromic composite layer (as defined above) disposed on a surface of a solid substrate by wet-processing techniques.

The term “suspension” denotes a dispersion comprising a continuous phase (in the literature sometimes referred to as an external phase e.p.) that is a liquid (herein referred to as the carrier liquid) and a dispersed phase (in the literature sometimes referred to as an internal phase i.p.) that is a solid and does not dissolve in said continuous phase which is liquid. Preparation of suspensions is known in the art.

The first suspension comprises a first carrier liquid. The second suspension comprises a second carrier liquid. Said first carrier liquid and said second carrier liquid have the same or different composition and are selected from the group consisting of water, methanol, ethanol, 1-propanol, 2-propanol, 2-butanol, iso-butanol, acetonitrile and propionitrile and mixtures thereof.

The first suspension provided in the process according to the first aspect of the present invention comprises nanoobjects comprising one or more electrochromic metal oxides.

The term “nanoobject” is defined in ISO/TS 27687:2008 (as published in 2008) and refers to an object having one, two or three external dimensions in the nanoscale, i.e. in the size range from approximately 1 nm to 100 nm. As regards the nanoobjects comprising one or more electrochromic metal oxides, nanoobjects in the form of primary particles having three external dimensions in the nanoscale are preferred. According to ISO/TS 27687:2008 those types of nanoobjects are referred to as nanoparticles. According to DIN 53206-1: 1972-08, the term “primary particles” refers to entities which are discernible as individuals by means of optical microscopy or transmission electron microscopy. Preferred nanoparticles are approximately isometric, i.e. the aspect ratio (longest : shortest direction) of all 3 orthogonal dimensions is in the range of from 1 to 2.

Electrochromic metal oxides are known in the art, see e.g. Mortimer, R. J.: “Electrochromic materials”, Annu. Rev. Mater. Res. 2011. 41:241-68 and Granqvist, C. G.: “Oxide electrochromics: An introduction to devices and materials”, Solar Energy Materials & Solar Cells 99 (2012) 1-13. The electrochromic metal oxides are preferably selected from the group consisting of oxides of Ti, V, Cr, Mn, Fe, Co, Ni, Nb, Mo, Rh, Ta, W, Ir, Ce and mixtures thereof. Preferred are oxides of Ti, V, Ni, Nb, Mo, Ta and W and mixtures thereof.

In an electrochromic device, the electrochromic effect of the electrochromic metal oxide is effected by applying an appropriate electrochemical potential so that a change of the oxidation state (anodic oxidation or cathodic reduction) of the metal in the electrochromic metal oxide occurs which is accompanied by an electrochromic effect as defined above. Preferably, in at least one of the involved oxidation states, the electrochromic metal oxide exhibits a color falling within the visible range of the electromagnetic spectrum (380 nm-780 nm). Also preferred are metal oxides (e.g. oxides of cerium) which exhibit a change of optical absorption e.g. in the UV or IR range of the electromagnetic spectrum without a visible color change, when changing the oxidation state (anodic oxidation or cathodic reduction) of the metal in the electrochromic metal oxide.

A nanoobject comprising one or more electrochromic metal oxides may consist of one or more electrochromic metal oxides. In this case, no other materials then electrochromic metal oxides are present within such nanoobject.

Alternatively, a nanoobject comprising one or more electrochromic metal oxides layer may consist of one or more electrochromic metal oxides and one or more other metal oxides which are not electrochromic. Preferably, said one or more metal oxides which are not electrochromic are selected from the group consisting of oxides of Si, Y, Pr, Nd, Sm, Eu, Hf, Zr, Ca, Zn, Sn, Ag, Cd, La, Pb and In and mixtures thereof.

Preparation of suitable metal oxide nanoobjects comprising one or more electrochromic metal oxides is known in the art. For instance, the metal oxide nanoobjects are nanoparticles synthesized by a gas phase pyrolysis process, preferably flame spray synthesis. Such nanoparticles are commercially available.

Preferred metal oxide nanoobjects are metal oxide nanoparticles (nanoparticles comprising one or more electrochromic metal oxides). The term “nanoparticles” is defined above. Particularly preferred are particles having a primary particle diameter of 1 nm to 100 nm, preferably 3 nm to 50 nm (measured by nitrogen absorption, X-Ray diffraction or transmission electron microscopy).

Preferably, said metal oxide nanoobjects exhibit a bimodal or multimodal size distribution. It is believed that bimodal or multimodal size distributions result in higher particle packing densities, thus resulting in lower layer porosity of the electrochromic composite layer.

Advantageously, the metal oxide nanoobjects are nanoparticles which in suspension have a hydrodynamic size D₉₀ of less than 100 nm (measured by dynamic light scattering or centrifugal sedimentation techniques).

Preferably, in said first suspension the concentration of dispersed nanoobjects comprising one or more electrochromic metal oxides is in the range of from 0.1 wt.-% to 20.0 wt.-%, preferably 2.0 wt.-% to 15.0 wt.-%, most preferably 5.0 wt.-% to 11.0 wt.-%.

In certain cases it is preferred that the first suspension further comprises one or more metal salts of formula (I)

(M^{a+})_{z}(R^{b-})_{y} (I),

wherein
M^{a+} represents a metal cation,
R^{b-} represents the corresponding salt anion,
a is 2, 3, 4 or 5,
b is 1, 2 or 3,
z is the least common multiple of a and b, divided by a
y is the least common multiple of a and b, divided by b
wherein at least a portion of said metal salts of formula (I) is physisorbed on the surfaces of said nanoobjects comprising one or more electrochromic metal oxides
wherein the molar fraction of metal ions M of the metal salts of formula (I) is in the range of from 0.02 to 6 mol %, based on the total amount of metal in the metal ions M of the metal salts of formula (I) and in the metal oxides in the nanoobjects.

The term physisorption, as used herein, defines adsorption in which the forces involved are intermolecular forces (van der Waals or electrostatic forces) and which do not involve a significant change in the electronic orbital patterns of the species involved (see: “International Union of pure and Applied Chemistry” (http://goldbook.iupac.org/P04667.html). In the context of the present application it denotes the adsorption of a molecule or ion on a surface by either electrostatic or van der Waals attraction. In contrast to chemisorption, a physisorbed molecule or ion does not alter its chemical properties upon adsorption. Accordingly, by physisorption covalent bonds are neither formed nor broken nor are atoms ionized or ions deionized.

Without being bound to theory, it is believed that the metal salts of formula (I) as defined above act as dispersing aids for the metal oxide nanoobjects and are at least partly physisorbed on the surface of the metal oxide nanoobjects and may be partly dissolved in the liquid phase of the suspension. The term “dispersing aid” as used herein denotes a substance, which is used to improve the separation of suspended particles and to prevent agglomeration or settling of said particles. In the context of the present invention the term “dispersing aid” is used for metal salts of formula (I) as defined herein which stabilize said first suspension comprising said metal oxide nanoobjects. The dispersing aid is different from the materials forming the liquid external phase (carrier liquid) of said first suspension.

As mentioned above, in said first suspension the surfaces of the metal oxide nanoobjects are at least partly coated with physisorbed metal salts of formula (I). The specific fractions of metal salts of formula (I) physisorbed on the surface of the metal oxide nanoobjects and dissolved in the in the liquid phase of the suspension are dependent on the specific combination of metal oxide nanoobjects/metal salts of formula (I).

Coating of metal oxide nanoobjects by said one or more metal salts of formula (I) may be achieved by procedures known in the art. For instance, said first carrier liquid and said metal oxide nanoobjects are combined, for example by mixing, ultrasonication or ball milling. To the obtained initial suspension, one or more metal salts of formula (I) as defined above are added. Coating of the nanoobjects with the one or more metal salts of formula (I) as defined above takes place during mixing at room temperature or upon heating. Alternatively, said first carrier liquid and said one or more metal salts of formula (I) are combined, for example by mixing. To the obtained initial solution of one or more metal salts of formula (I) in the carrier liquid, the metal oxide nanoobjects are added. Coating of the metal oxide nanoobjects with the one or more metal salts of formula (I) as defined above takes place during mixing at room temperature or upon heating.

In formula (I)

(M^{a+})_{z}(R^{b-})_{y} (I)

M^{a+} represents a metal cation,

R^{b-} represents the corresponding salt anion,

a is 2, 3, 4 or 5,

b is 1, 2 or 3,

z is the least common multiple of a and b, divided by a

y is the least common multiple of a and b, divided by b.

Thus, when a is 2 and b is 1, z is 1 and y is 2.

Thus, when a is 2 and b is 2, z is 1 and y is 1.

Thus, when a is 2 and b is 3, z is 3 and y is 2.

Thus, when a is 3 and b is 1 , z is 1 and y is 3.

Thus, when a is 3 and b is 2, z is 2 and y is 3.

Thus, when a is 3 and b is 3, z is 1 and y is 1.

Thus, when a is 4 and b is 1 , z is 1 and y is 4.

Thus, when a is 4 and b is 2, z is 1 and y is 2.

Thus, when a is 4 and b is 3, z is 3 and y is 4.

Thus, when a is 5 and b is 1 , z is 1 and y is 5.

Thus, when a is 5 and b is 2, z is 2 and y is 5.

Thus, when a is 5 and b is 3, z is 3 and y is 5.

Preferred are metal salts of formula (I) wherein

M represents one of Zn, Al, Sc, Ga, Y, Pb, Bi, Cu, Ni, Co, Fe, Mn, Cr, V, Ti, La, Mg, Ca, Sr and Ba, most preferably one of Zn, Al and Y

or

R^{b-} represents an organic anion selected from the group consisting of acetate, formiate, citrate, oxalate, or an inorganic anion selected from the group consisting of nitrate, difluorophosphate, hexafluorophosphate and tetrafluroborate.

More specifically, preferred are metal salts of formula (I) wherein

M represents one of Zn, Al, Sc, Ga, Y, Pb, Bi, Cu, Ni, Co, Fe, Mn, Cr, V, Ti, La, Mg, Ca, Sr and Ba, most preferably one of Zn, Al and Y

and

R^{b-} represents an organic anion selected from the group consisting of acetate, formiate, citrate, oxalate, or an inorganic anion selected from the group consisting of nitrate, difluorophosphate, hexafluorophosphate and tetrafluroborate.

Especially preferred metal salts of formula (I) are zinc diacteate, aluminium triacetate, yttrium triacetate, zinc dinitrate, aluminium trinitrate and yttrium trinitrate.

Metal salts of formula (I) as defined above are commercially available.

It is preferred that the metals M of the dispersing aid salts of formula (I) differ from the metals of the metal oxides in the metal oxide nanoobjects dispersed in said first suspension.

The molar fraction of metal in the metal ions M of the metal salts of formula (I) is in the range of from 0.02 to 6 mol %, based on the total amount of metal (i) in the metal ions M of the metal salts of formula (I) and (ii) in the metal oxides in the metal oxide nanoobjects. In this regard, any metal oxide present in the metal oxide nanoobjects is considered irrespective whether it is electrochromic or not. The specific molar fraction of the metal salts of formula (I) may depend on the specific surface exhibited by the nanoobjects and may be determined by the skilled person.

For further details regarding the metal salts of formula (I), reference is made to the non-prepublished patent application having the application numbers EP16155242 and PCT/EP2017/052648. The content of said patent applications is incorporated herein by reference.

The second suspension provided in the process according to the first aspect of the present invention comprises electronically conductive nanoobjects which do not comprise metal oxides.

Preferably, the electronically conductive nanoobjects are nanowires having a length in the range of from 1 μm to 100 μm, and a diameter in the range of from 1 nm to 100 nm, preferably 10 nm to 50 nm, most preferably 15 nm to 30 nm, length and diameter in each case being determined by transmission electron microscopy.

The term “nanowire” is defined in ISO/TS 27687:2008 (as published in 2008) and refers to an electronically conducting nanofiber. According to ISO/TS 27687:2008, nanofibers are nanoobjects with two similar external dimensions in the nanoscale and the third dimension significantly larger. The two similar external dimensions are considered to differ in size by less than three times and the significantly larger external dimension is considered to differ from the other two by more than three times. The largest external dimension is not necessarily in the nanoscale.

Preferably, said electronically conductive nanowires are nanowires consisting of materials selected from the group consisting of silver, copper, gold, platinum, tungsten and nickel and alloys of two or more metals selected from the group consisting of silver, copper, gold, platinum, tungsten and nickel.

Preferably said electronically conductive nanowires have a length in the range of from 1 μm to 100 μm, and a diameter in the range of from 1 nm to 100 nm, preferably 10 nm to 50 nm, most 5 preferably 15 nm to 30 nm, length and diameter in each case being determined by transmission electron microscopy.

Suitable nanowires are commercially available.

In said second suspension the concentration of dispersed electronically conducting nanoobjects is in the range of from 0.1 wt.-% to 2.0 wt,-%, most preferably 0.5 wt.-% to 1.0 wt.-%.

In the above-defined process according to the first aspect of the present invention, a third suspension is obtained by adding together said first suspension and said second suspension. Said third suspension comprises said nanoobjects comprising one or more electrochromic metal oxides (as defined above) and said electronically conductive nanoobjects (which do not comprise metal oxides) dispersed in a carrier liquid having a boiling point below 120° C. consisting of said first liquid and said second liquid. Preferably, said first suspension and said second suspension are added together in a volume ratio in the range of from 1:10 to 10:1, further preferably in a volume ratio in the range of from 1:8 to 8:1, most preferably in a volume ratio in the range of from 1:4 to 4:1.

In this regard, it is preferred that
in said first suspension the concentration of dispersed nanoobjects comprising one or more electrochromic metal oxides is in the range of from 0.1 wt.-% to 20.0 wt.-%, preferably 2.0 wt.-% to 15.0 wt.-%, most preferably 5.0 wt.-% to 11.0 wt.-%

and
in said second suspension the concentration of dispersed electronically conducting nanoobjects is in the range of from 0.1 wt.-% to 2.0 wt,-%, preferably 0.5 wt.-% to 1.0 wt.-%.

In the above-defined process according to the first aspect of the present invention, an ink which is suitable for preparing an electrochromic composite layer (as defined above) disposed on a surface of a solid substrate by wet-processing techniques is formed by admixing to said third suspension
one or more kinds of polymerisable monomers,
optionally one or more initiators for initiating radical polymerization of said one or more kinds of polymerisable monomers
at least one electrolyte having cations selected from the group consisting of H⁺, Li⁺, Na⁺, K⁺ wherein said electrolyte comprises at least one anion which is different from OH⁻ or at least one cation from the group consisting of Li⁺, Na⁺ and K⁺
a solvent capable of dissolving said electrolytes, wherein said solvent has a boiling point of 120° C. or higher.

Thus, an ink to be used in the process according to the present invention comprises
precursors (in the form of polymerizable monomers) of the organic polymer matrix of the electrochromic composite layer, and
the above-defined constituents of an electrochromic composite layer which are to be dispersed within said organic polymer matrix, and
a carrier liquid having a boiling point of less than 120° C. which does not become a constituent of the electrochromic composite layer but merely acts as a vehicle for wet-processing.

Suitable polymerizable monomers for forming an organic polymer matrix are known in the art and are commercially available. Preferred polymerizable monomers are co-polymerizable monomers selected from the group consisting of alkyl acrylates and alkyl methacrylates and co-polymerizable monomers selected from the group of hydroxyalkyl acrylates and hydroxyalkyl methacrylates.

The electrolyte is selected so that its anions are not electroactive in the range of electro-chemical potentials typically applied for operating an electrochromic device. Preferred electrolytes are selected from the group consisting of bis(trifluoromethane) sulfonimide, lithium difluorophosphate, lithium hexafluorophosphate, lithium tetrafluroborate, lithium nitrate, lithium bis(flurosulfonyl)imide, lithium bis(trifluoromethane)sulfonimide, lithium trifluoromethane sulfonate, lithium perchlorate, lithium bisoxalatoborate, lithium difluorooxalatoborate, water and lithium difluorobisoxalatophosphate.

The solvent for dissolving the electrolyte is selected to have a boiling point of 120° C. or higher, in order to allow the solvent to remain in the electrochromic composite layer when heat is applied during the steps of removing the carrier liquid and polymerizing the polymerizable monomers.

Due to the requirement of dissolution and dissociation of the electrolyte in the solvent having a boiling point of 120° C. or higher, suitable solvents are polar solvents. Preferred solvents are selected from the group consisting of carbonates, alkyl esters of saturated carbonic acids, polyethers, lactones and dinitriles and mixtures thereof.

Preferably, the step of forming said ink (as defined above) comprises preparing or providing a premixture comprising
one or more kinds of polymerisable monomers,
optionally one or more initiators for initiating radical polymerization of said one or more kinds of polymerisable monomers,
at least one electrolyte having cations selected from the group consisting of H⁺, Li⁺, Na⁺ and K⁺ and anions different from OH⁻,
a solvent capable of dissolving said electrolytes, wherein said solvent has a boiling point of 120° C. or higher

and admixing said premixture to said third suspension.

Surprisingly it has been found that the sequence of combining the constituents of the ink is of utmost importance for the stability of the obtained ink. More specifically it has been observed that agglomeration and sedimentation of nanoobjects in the ink occurs very fast when the above-defined sequence is not obeyed. For instance, adding a suspension of said metal oxide nanoobjects and/or said electronically conductive nanoobjects (as defined above) to a premixture comprising
one or more kinds of polymerisable monomers,
optionally one or more initiators for initiating radical polymerization of said one or more kinds of polymerisable monomers,
one or more electrolytes having cations selected from the group consisting of H⁺, Li⁺, Na⁺ and K⁺ and anions different from OH⁻,
a solvent capable of dissolving said electrolytes, wherein said solvent has a boiling point of 120° C. or higher

immediately results in agglomeration and sedimentation of the nanoobjects. Agglomeration of the nanoobjects occurs within a few seconds and can be monitored by visual inspection as the initially clear dispersion becomes cloudy.

Agglomeration of the nanoobjects in the ink would result in electrochromic layers which exhibit inhomogenities, e.g. patterns, due to uneven distribution of the nanoobjects.

Further preferably, the step of forming said ink (as defined above) comprises mechanical agitation of the ink, e.g. by means of shaking, jolting or by using devices selected from the group consisting of static mixers and dynamic mixers. Preferred static mixers are caterpillar mixers. Preferred dynamic mixers are reaction mixing pumps. Caterpillar mixers are most preferably used.

In this regard it is noted that agitation techniques like stirring and ultrasonication in some cases are not suitable. More specifically it was observed that stirring may lead to agglomeration of nanoobjects, while ultrasonication may cause breakdown of nanowires.

In a process according to the present invention, it is particularly preferred that said first suspension, said second suspension and said third suspension do not contain an electrolyte as defined above, because it has been observed that such electrolytes may have a detrimental influence on the stability of said suspensions, i.e. there is an increased tendency of agglomeration and sedimentation of the nanoobjects in the presence of such electrolytes.

Preferably said ink (as defined above) comprises
said carrier liquid having a boiling point below 120° C. in an amount of from 42.76 wt.-% to 99.97 wt.-%
said nanoobjects comprising one or more electrochromic metal oxides in a total amount of from 0.009 wt.-% to 12.53 wt.-%
said electronically conductive nanoobjects not comprising metal oxides in a total amount of from 0.001 wt.-% to 0.40 wt.-%
said polymerisable monomers in a total amount of from 0.00006 wt.-% to 40.08 wt.-%
said initiators for initiating radical polymerization of said polymerisable monomers in a total amount of from 0.000002 wt.-% to 1.05 wt.-%
said electrolytes having cations selected from the group consisting of H⁺, Li⁺, Na⁺, K⁺ wherein said each of said electrolytes comprises at least one anion which is different from OH⁻ or at least one cation from the group consisting of Li⁺, Na⁺ and K⁺ in a total amount of from 0.001 wt.-% to 1.05 wt.-%
said solvent capable of dissolving said electrolytes, wherein said solvent has a boiling point of 120° C. or higher, in an amount of from 0.00003 wt.-% to 6.33 wt.-%

in each case related to the total weight of the ink.

The specific amount of each constituent may depend on the specific selection of this and other constituents, and may be by adjusted accordingly by the skilled person.

In the above-defined process according to the present invention, a wet film is formed by applying the formed ink to a surface of a solid substrate. Said wet film formed on said surface of said solid substrate contains
precursors (in the form of polymerizable monomers) of the organic polymer matrix of the electrochromic composite layer, and
the above-defined constituents of an electrochromic composite layer which are to be dispersed within said organic polymer matrix
and said carrier liquid having a boiling point of less than 120° C.

Depending on the specific type of electrochromic device, the substrate is optically transparent or non-transparent. Optically transparent substrates exhibit a light transmission of 80% or more measured according to DIN EN 410.

Typically said substrate layer comprises one or more materials selected from the group consisting of glasses, metals and organic polymers.

Preferred types of glass are e.g. float glass, low iron float glass, heat strengthened glass and chemically strengthened glass. Optionally, the glass has a low-emissivity (low-e) coating, sun-protection coating or any other coating on the surface facing away from the electrochromic composite layer. Optionally, antireflection (AR) coating can be used to enhance the transmittance through optical devices, and a variety of low refractive index, nanoporous, and/or nanostructured coatings can be applied to glass and plastic substrates (see for example: C. G. Granqvist, Transparent conductors as solar energy materials: a panoramic review, Solar Energy Mater. Solar Cells 91, 1529-1598 (2007)). It has been demonstrated that coating both sides of a glass pane with self-assembled silica nanoparticle films made it possible to obtain a transmittance as large as 99.5% in the middle of the luminous spectrum (cf. P. Nostel, A. Roos, and B. Karlsson, Optical and mechanical properties of sol-gel antireflective films for solar energy applications, Thin Solid Films 351, 170-175 (1999); S. E. Yancey, W. Zhong, J. R. Heflin, and A. L. Ritter, The influence of void space on antireflection coatings of silica nanoparticle self-assembled films, J. Appl. Phys. 99, 034313 (2006).

Preferred organic polymers are selected from the group consisting of polymethylmethacrylate (PMMA, commercially available e.g. as Plexiglas™), polycarbonate (PC), polyethylene (PE), low density polyethylene (LDPE), linear low density polyethylene (LLDPE), polypropylene (PP), low density polypropylene (LDPP), polyethylene therephthalate (PET), glycol modified polyethylene therephthalate, polyethylene naphthalate (PEN), cellulose acetate butyrate, polylactide (PL), polystyrene (PS), polyvinyl chloride (PVC), polyvinylbutyral (commercially available e.g. as Mowital LPBF™, Trosifol OG™), ethylene-vinylacetate-copolymers (EVA), polyurethanes (PU), ionomer resins (commercially available e.g. Sentryglas™).

Depending on the type of the electrochromic device, said solid substrate is in a form selected from the group consisting of foils, films, webs, panes and plates. With regard to efficiency of manufacturing of electrochromic devices, rollable substrates (substrates which are sufficiently flexible to be taken up on a roll and returned to flatness in an undamaged state), e.g. foils and films, are preferred, so as to enable implementation of continuous, e.g. roll-to-roll processing steps in manufacturing of electrochromic devices.

Preferably, said solid substrate has a thickness in the range of from 0.1 μm to 1000 μm, preferably 1 μm to 500 μm and more preferably from 50 μm to 200 μm.

In some cases, the surface of the substrate layer upon which the electrochromic composite layer is disposed comprises an electronically conductive material, preferably an optically transparent electronically conductive material. Preferred optically transparent conducting materials are transparent conducting oxides (TOO), preferably selected from the group consisting of ITO (indium doped tin oxide), AZO (aluminum doped zinc oxide), IGZO (indium gallium doped zinc oxide), GZO (gallium doped zinc oxide), FTO (fluorine doped tin oxide), indium oxide, tin oxide and zinc oxide. In some cases, the surface of the substrate layer upon which the electrochromic composite layer is disposed comprises one or more metallic electronically conductive materials, wherein the metals are preferably selected from the group consisting of Cu, Ag, Au, Pt and Pd. Preferably, any metal at the substrate surface is present in the form of a structure which is substantially optically transparent, e.g. in the form of nanowires.

However, it has been found that in preferred cases the electronic in-plane conductivity of the electrochromic composite layer is sufficiently high so that providing the substrate surface with an electronically conductive material can be omitted. This is an important advantage because manufacturing of the electrochromic device is facilitated and the costs are reduced.

Preferably, said ink is applied to said surface of said solid substrate by coating or printing. Suitable coating techniques are, for example roll-to-roll-, slot-die-, spray-, ultrasonic spray-, dip-, reel-to-reel-, and blade coating. Suitable printing techniques are e.g. ink-jet-, pad-, offset-, gravure-, screen-, intaglio-, sheet-to-sheet- printing. These techniques are known in the art and are commercially available. Such techniques are generally considered advantageous for large scale production, when compared to vacuum-based techniques.

Preferably the wet film formed on said surface of said solid substrate has a thickness in the range of from 5 μm to 5000 μm, preferably 5 μm to 3000 μm, particularly preferably 5 μm to 1000 μm. The wet film thickness is adjustable by appropriate selection of related technical parameters of the coating or printing technique, which determine the amount of ink applied per area of the surface of the solid substrate.

It is preferably to apply the ink to the substrate as soon as possible after forming said ink, in order to avoid agglomeration and sedimentation of the dispersed nanoobjects. Therefore, in the process according to the present invention, applying said ink to said surface of said solid substrate is preferably carried out not later than 24 hours, more preferably not later than 20 hours further preferably not later than 12 hours, particularly preferably not later than 8 hours, especially preferably not later than 4 hours after completing forming said ink.

In the above-defined process according to the first aspect of the present invention, said carrier liquid having a boiling point below 120° C. which is not a constituent of the electrochromic composite film but merely a vehicle for wet processing, is removed from the wet film formed on said surface of said solid substrate. Preferably, the carrier liquid having a boiling point of less than 120° C. is removed by exposing the wet film formed on said surface of said solid substrate to air having a temperature in the range of from 20° C. to 120° C., preferably a temperature in the range of from 40° C. to 120° C., most preferably a temperature in the range of from 80° C. to 120° C.

When the carrier liquid having a boiling point of less than 120° C. is removed, the film formed on said surface of said solid substrate contains
precursors (in the form of polymerizable monomers) of the organic polymer matrix of the electrochromic composite layer, and
the above-defined constituents of an electrochromic composite layer which are to be dispersed within said organic polymer matrix.

In the above-defined process according to the present invention, the polymerizable monomers are polymerized on said surface of said solid substrate, thus forming the above-defined organic polymer matrix. In this way, an electrochromic composite layer comprising
an organic polymer matrix as defined above which is obtained by polymerizing the polymerizable monomers, and
the above-defined constituents which are dispersed within said organic polymer matrix

is formed.

Polymerization of the polymerizable monomers is preferably initiated by irradiation, especially irradiation having a wavelength in the range of from 360 nm to 420 nm, in the presence of an initiator which decomposes into radicals when exposed to said irradiation. Suitable copolymerization initiators are known in the art and commercially available.

In certain cases, preparing said electrochromic composite layer further comprises the step of annealing the layer formed on the surface of the solid substrate after polymerizing the polymerizable monomers to a temperature in the range of from 40° C. to 120° C., preferably a temperature in the range of from 80° C. to 120° C.

In certain cases, after completing said polymerization of said polymerizable monomers on the surface of said substrate, a sequence comprising the steps of
forming a wet film by applying the formed ink on the surface of the layer wherein the polymerizable monomers have been polymerized
removing said carrier liquid having a boiling point below 120° C. from said wet film
polymerizing said polymerizable monomers in the layer
optionally annealing the layer after polymerizing the polymerizable monomers wherein annealing is carried out at a temperature in the range of from 40° C. to 120° C.

is carried out and optionally repeated at least once.

In certain cases, after completing annealing the layer formed on the surface of the solid substrate, a sequence comprising the steps of
forming a wet film by applying the formed ink on the surface of the layer wherein the polymerizable monomers have been polymerized,
removing said carrier liquid having a boiling point below 120° C. from said wet film,
polymerizing said polymerizable monomers in the layer
optionally annealing the layer after polymerizing the polymerizable monomers wherein annealing is carried out at a temperature in the range of from 40° C. to 120° C.

is carried out and optionally repeated at least once.

Generally, the number of ink application steps depends on the desired thickness of the electrochromic layer to be formed. The thickness of electrochromic composite layers obtainable by the process described herein is in the range of from 0.05 μm to 500 μm, preferably of from 0.05 μm to 50 μm, most preferably of from 1 μm to 30 μm. Said thickness may be determined by profilometry, atomic force microscopy or electron microscopy.

Optionally, an additional functional layer which is not electrochromic composite layer as defined above is deposited on the surface of the electrochromic composite layer facing away from the substrate layer.

Preferred processes according to the first aspect of the present invention are those wherein two or more of the above-defined preferred features are combined.

A process according to a second aspect of the present invention comprises preparing an electrochromic composite layer disposed on a surface of a solid substrate (according to the first aspect of the present invention as defined above) and further comprises preparing an ionically conductive separator layer disposed on the surface of said electrochromic composite layer facing away from said solid substrate,

wherein preparing said ionically conductive separator layer comprises the steps of
forming on said surface of the electrochromic composite layer a wet film by applying to said surface an ink for preparing the ionically conductive separator layer, said ink comprising
   one or more kinds of polymerisable monomers,
   optionally one or more initiators for initiating radical polymerization of said one or more kinds of polymerisable monomers
   optionally one or more electrolytes having cations selected from the group consisting of H⁺, Li⁺, Na⁺ and K⁺
   a solvent capable of dissolving said electrolytes, wherein said solvent has a boiling point of 120° C. or higher
   optionally a carrier liquid having a boiling point below 120° C.
in case the ink contains a carrier liquid having a boiling point below 120° C. removing the carrier liquid having a boiling point below 120° C. from the wet film formed on to the surface of the electrochromic composite layer
at least partially polymerizing the polymerizable monomers in the layer formed on to the surface of the solid substrate.

At least partially polymerizing the polymerizable monomers in the layer formed on to the surface of the solid substrate means that the degree of conversation of the double bonds in the monomers is significantly below 96%, preferably 90% or less, further preferably 80% or less, more preferably 70% or less, particularly preferably 60% or less, or 50% or less. In cases where the process according to the second aspect of the present invention involves partial polymerization of the polymerizable monomers, polymerization is completed in a later process stage (see below).

Said ionically conductive separator layer comprises
a matrix formed of one or more organic polymers obtained by at least partially polymerizing the polymerizable monomers and
dispersed within said matrix at least one electrolyte having cations selected from the group consisting of H⁺, Li⁺, Na⁺ and K⁺ dissolved in a solvent having a boiling point of 120° C. or higher.

Said ionically conductive separator is ionically conductive but virtually electronically insulating. In an electrochromic device, it electronically separates the electrochromic composite layer and the counter electrode.

Said ionically conductive separator layer preferably has a thickness in the range of from 0.05 μm to 500 μm, preferably 0.05 μm to 50 μm, most preferably 1 μm to 50 μm. Thickness may be determined by profilometry, atomic force microscopy or electron microscopy.

In certain cases, said ink for preparing the ionically conductive separator layer comprises a carrier liquid, preferably selected from the group consisting of water, methanol, ethanol, propanol, 1-propanol, 2-propanol, 2-butanol, iso-butanol, acetonitrile and propionitrile. However, in said ink for preparing an ionically conductive separator layer as defined above a carrier liquid as a vehicle for wet processing can be omitted, because said ink does not comprise non-dissolved matter, in contrast to the above-described ink for preparing an electrochromic composite layer.

In specific cases, said ink for preparing the ionically conductive separator layer does not comprise an electrolyte. It has been found that ions from the electrolyte which is present in electrochromic composite layer and in the counter electrode layer may enter the separator layer by diffusion and migration, thereby providing for sufficient ionic conductivity across the separator layer. For this approach it is preferred to keep the thickness of the ionically conductive separator layer as low as possible, in order to ensure a sufficient concentration of ions throughout the whole volume of the separator layer.

Alternatively, water is used as the electrolyte for the ionically conductive separator layer. Water as the electrolyte of the ionically conductive separator layer may be introduced by using an ink comprising a carrier liquid consisting of water and another liquid having a boiling point of less than 120° C. (e.g. ethanol or 2-propanol). In the suspension according to the present invention, said carrier liquid and said solvent having a boiling point of 120° C. or more (e.g. propylene carbonate) form a single liquid phase. The amount of water that remains in said system consisting of water and two other liquids (one having a boiling point of less than 120° C. and one having a boiling point of 120° C. or higher) can be estimated according to Raoult's law or can be determined from experimental data, as known by the skilled person.

Suitable polymerizable monomers for forming an organic polymer matrix are known in the art and are commercially available. Preferred polymerizable monomers are copolymerizable monomers selected from the group consisting of alkyl acrylates and alkyl methacrylates and co-polymerizable monomers selected from the group of hydroxyalkyl acrylates and hydroxyalkyl methacrylates.

The electrolytes are selected so that their anions are not electroactive in the range of electrochemical potentials typically applied for operating an electrochromic device. Preferred electrolytes are selected from the group consisting of bis(trifluoromethane) sulfonimide, lithium difluorophosphate, lithium hexafluorophosphate, lithium tetrafluroborate, lithium nitrate, lithium bis(flurosulfonyl)imide, lithium bis(trifluoromethane)sulfonimide, lithium trifluoromethane sulfonate, lithium perchlorate, lithium bisoxalatoborate, lithium difluorooxalatoborate, water and lithium difluorobisoxalatophosphate.

The solvent for dissolving the electrolyte is selected to have a boiling point of 120° C. or higher, in order to allow the solvent to remain in the ionically conductive separator layer when heat is applied during the steps of removing the carrier liquid (if present) and polymerizing the polymerizable monomers.

Due to the requirement of dissolution and dissociation of the electrolyte in the solvent having a boiling point of 120° C. or higher, suitable solvents are polar solvents. Preferred solvents are selected from the group consisting of carbonates, alkyl esters of saturated carbonic acids, polyethers, lactones and dinitriles and mixtures thereof.

Preferably, in the ink for preparing the ionically conductive separator layer,
said polymerisable monomers
said electrolytes having cations selected from the group consisting of H⁺, Li⁺, Na⁺, and K⁺
and said a solvent capable of dissolving said electrolytes, wherein said solvent has a boiling point of 120° C. or higher

are the same as the polymerisable monomers, the electrolytes and the solvent, resp., of the ink used for preparing the electrochromic composite layer upon which the ionically conductive separator is disposed.

Preferably, said ink for preparing the ionically conductive separator layer is applied to said surface of said electrochromic composite layer by coating or printing. Suitable coating techniques are, for example roll-to-roll-, slot-die-, spray-, ultrasonic spray-, dip-, reel-to-reel-, and blade coating. Suitable printing techniques are e.g. ink-jet-, pad-, offset-, gravure-, screen-, intaglio-, sheet-to-sheet- printing. These techniques are known in the art and are commercially available. Such techniques are generally considered advantageous for large scale production, when compared to vacuum-based techniques.

Polymerization of the polymerizable monomers is preferably initiated by irradiation, especially irradiation having a wavelength in the range of from 360 nm to 420 nm, in the presence of an initiator which decomposes into radicals when exposed to said irradiation. Suitable copolymerization initiators are known in the art and commercially available.

In certain cases, after completing said polymerization of said polymerizable monomers a sequence comprising the steps of
forming a wet film by applying the formed ink on the surface of the layer wherein the polymerizable monomers have been polymerized
removing said carrier liquid having a boiling point below 120° C. from said wet film
polymerizing said polymerizable monomers in the layer

is carried out and optionally repeated at least once, depending on the desired thickness of the ionically conductive separator layer.

If on the surface of the electrochromic composite layer facing away from the substrate layer an additional functional layer is disposed which is not an electrochromic composite layer as defined above and which is not an ionically conductive separator layer (i.e. not a layer which is ionically conductive but virtually electronically insulating) than in a process according to the second aspect of the present invention an ionically conductive separator layer is prepared on the surface of said functional layer facing away from said electrochromic composite layer. Such additional functional layers are known in the art, see e.g. C. G. Granquist, Handbook of Inorganic Electrochromic Materials.

Preferred processes according to the second aspect of the present invention are those wherein two or more of the above-defined preferred features are combined.

A process according to a third aspect of the present invention further comprises applying a counter electrode layer, wherein applying said counter electrode layer comprises the steps of
preparing or providing a layer assembly comprising a counter electrode layer disposed on a surface of a second solid substrate and optionally a second ionically conductive separator layer disposed on the surface of said counter electrode layer facing away from said second solid substrate
stacking said layer assembly on top of the ionically conductive separator layer of a layer structure prepared by the process according to the second aspect of the present invention as described above, so that a resulting layer structure is obtained having an ionically conductive separator layer between an electrochromic composite layer (i.e. the electrochromic composite layer of said layer structure prepared by the process according to the second aspect of the present invention as described above) and said counter electrode layer.

Accordingly, said solid substrates form the lowermost layer and the uppermost layer of said resulting layer structure.

Said counter electrode layer comprises an electroactive material capable of repeatedly inserting and releasing ions to compensate for changes of the oxidation state of the metal of the electrochromic metal oxide in the metal oxide nanoobjects present in the electrochromic composite layer. Upon operation of the electrochromic device the electrochromic composite layer and the counter electrode layer are connected to a direct voltage source. Between the electrochromic composite layer and the counter electrode, virtually no electrons are transferred across the ionically conductive separator layer.

Said counter electrode layer may comprise an electroactive material which independent from its state of oxidation is substantially optically transparent or has an electrochromic effect involving a color change significantly less pronounced than that of the electrochromic metal oxide in the metal oxide nanoobjects of the electrochromic composite layer. Suitable electroactive materials are known in the art and include, but are not limited to tin oxide, cerium oxide, transparent polymers capable of intercalating lithium ions and crystalline W0₃.

Alternatively, said counter electrode layer comprises an electroactive material which is an electrochromic material exhibiting an electrochromic effect having a dependence on the applied electrochemical potential which is opposite to the electrochromic effect of the electrochromic metal oxide in the electrochromic composite layer. For instance, the electrochromic oxide of the electrochromic composite layer colors during anodic oxidation and discolors during cathodic reduction, and the electrochromic material in the counter electrode colors during cathodic reduction and discolors during anodic oxidation, or vice versa. Alternatively, the electrochromic oxide of the electrochromic composite layer adopts a dark color during anodic oxidation and a less dark color during cathodic reduction, and the electrochromic material in the counter electrode adopts a dark color during cathodic reduction and a less dark color during anodic oxidation, or vice versa.

Herein, preferably said counter electrode layer is an electrochromic composite layer as defined above, preferably an electrochromic composite layer prepared as described above. Accordingly, said layer assembly used in the process according to the third aspect of the present invention is preferably a second layer structure prepared by a process according to the first or second aspect of the present invention as described above.

Thus, in the process according to the third aspect of the present invention, a second layer structure prepared by a process according to the first or second aspect of the present invention (as described above) is stacked on top of the ionically conductive separator layer of a first layer structure (prepared by a process according to the second aspect of the present invention as defined above), so that a resulting layer structure is obtained having an ionically conductive separator layer between the electrochromic composite layer of said first layer structure and the electrochromic composite layer of said second layer structure, and said first and second solid substrates form the lowermost layer and the uppermost layer and of said resulting layer structure.

In a first alternative, said second layer structure is prepared by a process according to the first aspect of the present invention. Said second layer structure which is prepared by a process according to the first aspect of the present invention is stacked on top of the ionically conductive separator layer of a first layer structure (prepared by a process according to the second aspect of the present invention), so that a resulting layer structure is obtained having an ionically conductive separator layer between the electrochromic composite layer of said first layer structure and the electrochromic composite layer of said second layer structure, and said first and second solid substrates form the lowermost layer and the uppermost layer of said resulting layer structure.

In this regard it is preferred that the polymerizable monomers in the ionically conductive separator layer of the first layer structure are only partially polymerized (as defined above), and polymerization is completed after stacking the second layer structure on top of the first layer structure, thereby achieving a bonding between the ionically conductive separator layer of the first layer structure and the electrochromic composite layer of the second layer structure.

Alternatively, bonding between the ionically conductive separator layer of the first layer structure and the electrochromic composite layer of the second layer structure is achieved by forming between the adjacent surfaces of said ionically conductive separator layer and said electrochromic composite layer a wet film by applying an ink comprising
one or more kinds of polymerisable monomers,
optionally one or more initiators for initiating radical polymerization of said one or more kinds of polymerisable monomers
optionally one or more electrolytes having cations selected from the group consisting of H⁺, Li⁺, Na⁺ and K⁺
a solvent capable of dissolving said electrolytes, wherein said solvent has a boiling point of 120° C. or higher

wherein in said ink said polymerisable monomers, said electrolytes and said solvent are identical with the corresponding constituents of the ink used for preparing the ionically conductive separator layer of the first layer structure

wherein said ink does not comprise a carrier liquid or any other constituents which are not constituents of an ionically conductive separator layer (as defined above), so that no removal of constituents from the wet film is necessary

and polymerizing said polymerizable monomers.

Further alternatively, both measures for achieving a bonding between the ionically conductive separator layer of the first layer structure and the electrochromic composite layer of the second layer structure are combined.

According to this first alternative, said second layer structure is prepared by a process comprising preparing an electrochromic composite layer disposed on a surface of a second solid substrate, wherein preparing said electrochromic composite layer comprises the steps of
providing a first suspension comprising nanoobjects comprising one or more electrochromic metal oxides dispersed in a first carrier liquid having a boiling point below 120° C., wherein said electrochromic metal oxides are different from the electrochromic metal oxides in the electrochromic composite layer of the first layer structure
providing a second suspension comprising electronically conductive nanoobjects dispersed in a second carrier liquid having a boiling point below 120° C., said electronically conductive nanoobjects not comprising metal oxides
adding together said first suspension and said second suspension to obtain a third suspension comprising said nanoobjects comprising one or more electrochromic metal oxides and said electronically conductive nanoobjects dispersed in a carrier liquid having a boiling point below 120° C. consisting of said first liquid and said second liquid
forming an ink by admixing to said third suspension
   one or more kinds of polymerisable monomers,
   optionally one or more initiators for initiating radical polymerization of said one or more kinds of polymerisable monomers
   at least one electrolyte having cations selected from the group consisting of H⁺, Li⁺, Na⁺, K⁺ wherein said electrolyte comprises at least one anion which is different from OH⁻ or at least one cation from the group consisting of Li⁺, Na⁺ and K⁺
   a solvent capable of dissolving said electrolytes, wherein said solvent has a boiling point of 120° C. or higher
forming on said surface of said second solid substrate a wet film by applying the formed ink to said surface of said solid substrate
removing said carrier liquid having a boiling point below 120° C. from the wet film formed on said surface of said solid substrate
polymerizing the polymerizable monomers on said surface of said solid substrate.

Statements regarding specific and preferred features of electrochromic composite layers and processes for preparing them according to the above-described first aspect of the present invention also apply to the electrochromic composite layer of said second layer structure.

In a second alternative, said second layer structure is prepared by a process according to the second aspect of the present invention. Said second layer structure which is prepared by a process according to the second aspect of the present invention is stacked on top of the ionically conductive separator layer of a first layer structure (prepared by a process according to the second aspect of the present invention), so that a resulting layer structure is obtained having a resulting ionically conductive separator layer which consists of said first ionically conductive separator layer and said second ionically conductive separator layer, between the electrochromic composite layer of said first layer structure and the electrochromic composite layer of said second layer structure, and said first and second solid substrates form the lowermost layer and the uppermost layer of said resulting layer structure.

In this regard it is preferred that the polymerizable monomers in the ionically conductive separator layer of the first and of the second layer structure are only partially polymerized (as defined above), and polymerization is completed after stacking the second layer structure on top of the first layer structure, thereby achieving a bonding between the ionically conductive separator layers of the first and of the second layer structure

Alternatively, bonding between the ionically conductive separator layers of the first and of the second layer structure is achieved by forming between the adjacent surfaces of said ionically conductive separator layers a wet film by applying an ink comprising
one or more kinds of polymerisable monomers,
optionally one or more initiators for initiating radical polymerization of said one or more kinds of polymerisable monomers
optionally one or more electrolytes having cations selected from the group consisting of H⁺, Li⁺, Na⁺ and K⁺
a solvent capable of dissolving said electrolytes, wherein said solvent has a boiling point of 120° C. or higher

wherein in said ink said polymerisable monomers, said electrolytes and said solvent are identical with the corresponding constituents of the ink used for preparing the ionically conductive separator layers of the first and the second layer structure

wherein said ink does not comprise a carrier liquid or any other constituents which are not constituents of an ionically conductive separator layer (as defined above), so that no removal of constituents from the wet film is necessary and polymerizing said polymerizable monomers.

Further alternatively, both measures for achieving a bonding between the ionically conductive separator layers of the first and of the second layer structure are combined.

According to said second alternative, said second layer structure is prepared by a process according to the second aspect of the present invention as described above, i.e. a process comprising preparing an electrochromic composite layer disposed on a surface of a second solid substrate (according to the first aspect of the present invention as defined above) and further comprising preparing an ionically conductive separator layer disposed on the surface of the electrochromic composite layer facing away from the second solid substrate, wherein preparing said ionically conductive separator layer comprises the steps of
forming on said surface of the electrochromic composite layer a wet film by applying to said surface an ink comprising
   one or more kinds of polymerisable monomers, optionally one or more initiators for initiating radical polymerization of said one or more kinds of polymerisable monomers
   optionally one or more electrolytes having cations selected from the group consisting of H⁺, Li⁺, Na⁺ and K⁺
   a solvent capable of dissolving said electrolytes, wherein said solvent has a boiling point of 120° C. or higher
wherein in said ink said polymerisable monomers, said electrolytes and said sok vent are preferably identical with the corresponding constituents of the ink used for preparing the ionically conductive layer of the first layer structure
optionally a carrier liquid having a boiling point below 120° C.
in case the ink contains a carrier liquid having a boiling point below 120° C. removing the carrier liquid having a boiling point below 120° C. from the wet film formed on to the surface of the electrochromic composite layer
at least partially polymerizing the polymerizable monomers in the layer formed on to the surface of the electrochromic composite layer.

Statements regarding specific and preferred features of ion conductive separator layers and processes for preparing them according to the above-described second aspect of the present invention also apply to the electrochromic composite layer of said second layer structure.

A preferred process for preparing a layer structure according to the third aspect of the present invention as defined above further comprises attaching a first support layer to the surface of the first solid substrate facing away from the electrochromic composite layer and/or attaching a second support layer to the surface of the second solid substrate facing away from said counter electrode layer. Preferably, a first support layer is attached to the surface of the first solid substrate facing away from the electrochromic composite layer and a second support layer is attached to the surface of the second solid substrate facing away from said counter electrode layer. In this regard, it is particularly preferred that the first and second solid substrate comprise materials from the group of organic polymers and are in the form of foils, films, webs, and the first and second support layer comprise glass.

Furthermore, it is preferred that a third support layer is attached to the surface of the first support layer facing away from the first solid substrate and/or a fourth support layer is attached to the surface of the second support layer facing away from the second solid substrate. In this regard it is particularly preferred that a third support layer is attached to the surface of the first support layer facing away from the first solid substrate and a fourth support layer is attached to the surface of the second support layer facing away from the second solid substrate. In this regard, it is particularly preferred that the first, second, third and fourth support layer comprise glass.

Said support layers comprise one or more materials selected from the group consisting of glasses, metals and organic polymers. Preferred types of glass are e.g. float glass, low iron float glass, heat strengthened glass and chemically strengthened glass. Optionally, the glass has a low-emissivity (low-e) coating, sun-protection coating or any other coating on the surface facing away from the electrochromic composite layer.

Optionally, antireflection (AR) coating can be used to enhance the transmittance through optical devices, and a variety of low refractive index, nanoporous, and/or nanostructured coatings can be applied to glass and plastic substrates (see for example: C. G. Granqvist, Transparent conductors as solar energy materials: a panoramic review, Solar Energy Mater. Solar Cells 91, 1529-1598 (2007)). It has been demonstrated that coating both sides of a glass pane with self-assembled silica nanoparticle films made it possible to obtain a transmittance as large as 99.5% in the middle of the luminous spectrum (cf. P. Nostel, A. Roos, and B. Karlsson, Optical and mechanical properties of sol-gel antireflective films for solar energy applications, Thin Solid Films 351, 170-175 (1999); S. E. Yancey, W. Zhong, J. R. Heflin, and A. L. Ritter, The influence of void space on antireflection coatings of silica nanoparticle self-assembled films, J. Appl. Phys. 99, 034313 vol. 1-10 (2006).

Preferred organic polymers are selected from the group consisting of polymethylmethacrylate (PMMA, commercially available e.g. as Plexiglas™), polycarbonate (PC), polyethylene (PE), low density polyethylene (LDPE), linear low density polyethylene (LLDPE), polypropylene (PP), low density polypropylene (LDPP), polyethylene therephthalate (PET), glycol modified polyethylene therephthalate, polyethylene naphthalate (PEN), cellulose acetate butyrate, polylactide (PL), polystyrene (PS), polyvinyl chloride (PVC), polyvinylbutyral (commercially available e.g. as Mowital LPBF™, Trosifol OG™), ethylene-vinylacetate-copolymers (EVA), polyurethanes (PU), ionomer resins (commercially available e.g. Sentryglas™)

Attaching said first resp. second support layer to said first resp. second solid substrate preferably comprises applying an adhesive between the support layer and the surface of the solid substrate to which said support layer has to be attached. Attaching said third resp. fourth support layer to said first resp. second support layer preferably comprises applying an adhesive. Suitable adhesives are thermoplastics, e.g. polyvinylbutyral, polyvinylalcohol, polyvinylacetate, ethylene-vinylacetate-copolymers, polyurethanes, ionomer resins (commercially available e.g. under the trade name SentryGlas®) and polymethylmethacrylate (PMMA).

A process for preparing a layer structure according to the third aspect of the present invention as defined above may further comprise a preformation treatment. The term “preformation” is used in the context of the present invention to generally denote treatments which serve to precondition the electrodes of an electrochromic device before, during and/or after device assembly in order to increase device performance and device stability by adjusting charge insertion/extraction in each electrode and charge balancing between these two electrodes. Suitable preformation treatments include, but are not limited to, chemical treatments (e.g. exposure to a gas e.g. ozone) and electrochemical treatments (e.g. application of a predetermined electrochemical potential for a predetermined duration, or subjecting the electrochromic material to one or more electrochromic switch cycles).

A process for preparing a layer structure to the third aspect of the present invention as defined above may comprise further steps wherein auxiliary elements which serve one or more purposes like protection and easy handling, are added. Such auxiliary elements do no become part of the electrochromic device. Such auxiliary elements are e.g. removable support layers, removable protection layers, removable separation layers, bobbins for rolling etc.

Preferred processes according to the third aspect of the present invention are those wherein two or more of the above-defined preferred features are combined.

A further aspect of the present invention relates to a process for manufacturing an electrochromic device, said process comprising preparing one or more layer structures according to the process of the third aspect of the present invention as described above or providing one or more layer structures manufactured according to the process of the third aspect of the present invention as described above. In a preferred process for manufacturing an electrochromic device, two or more layer structures manufactured according to the process of the third aspect of the present invention as described above are arranged on top of each other, so that the electrochromic effect of said two or more layer structures are combined. The electrochromic metal oxides in the electrochromic composite layers of said two or more layer structures may be the same or different.

A process for manufacturing an electrochromic device typically comprises further steps wherein one or more elements which are necessary for the function of said electrochromic device (e. g. electrical connections, switches, controlling units, supporting structures) are integrated with one or more layer structures prepared according to the process described above.

Preferred electrochromic devices are selected from the group consisting of
facade and roof elements, e.g. windows (also referred to as “smart windows”), insulation glass units, skylights, roof windows etc.
windows in transportation vehicles for e.g. aircrafts, trains, cars and trucks,
interior construction and design elements for buildings or vehicles, e.g. shower cabins, doors, separation elements, head up displays, cabin walls, room dividers etc.
displays and visualization optics, e.g. for computers, laptops, monitors, cell phones, vehicles, head up displays, dynamic backplanes as part of displays and tablet personal computers
electrochromic mirrors, e.g. rear view mirrors for vehicles,
sunglasses for daylight and night scopes.

Non-limiting aspects of the present invention will be described by way of example with reference to the accompanying figures, which are schematic and are not intended to be drawn to scale. For purposes of clarity, not every component is labeled in every figure, nor is every component of each aspect of the invention shown in each figure.

In the figures:

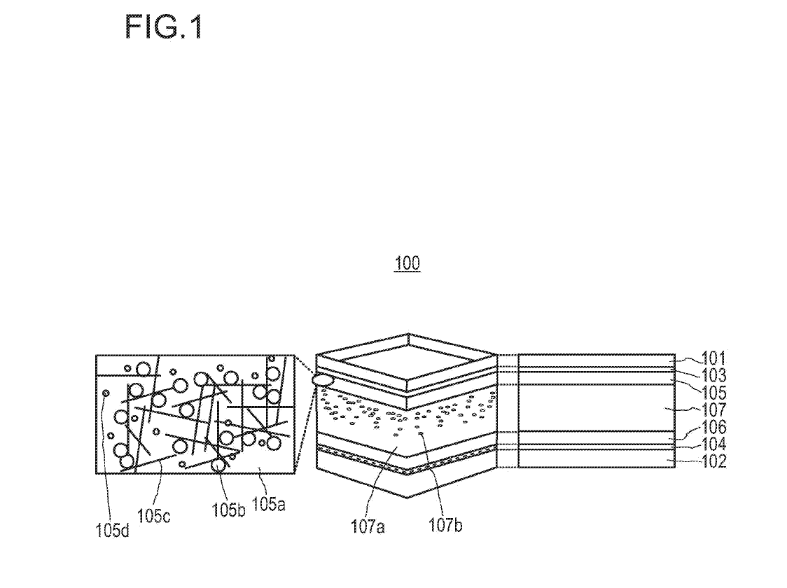

FIG. 1 is a schematic representation of a preferred layer structure obtainable by a process according to a third aspect of the present invention

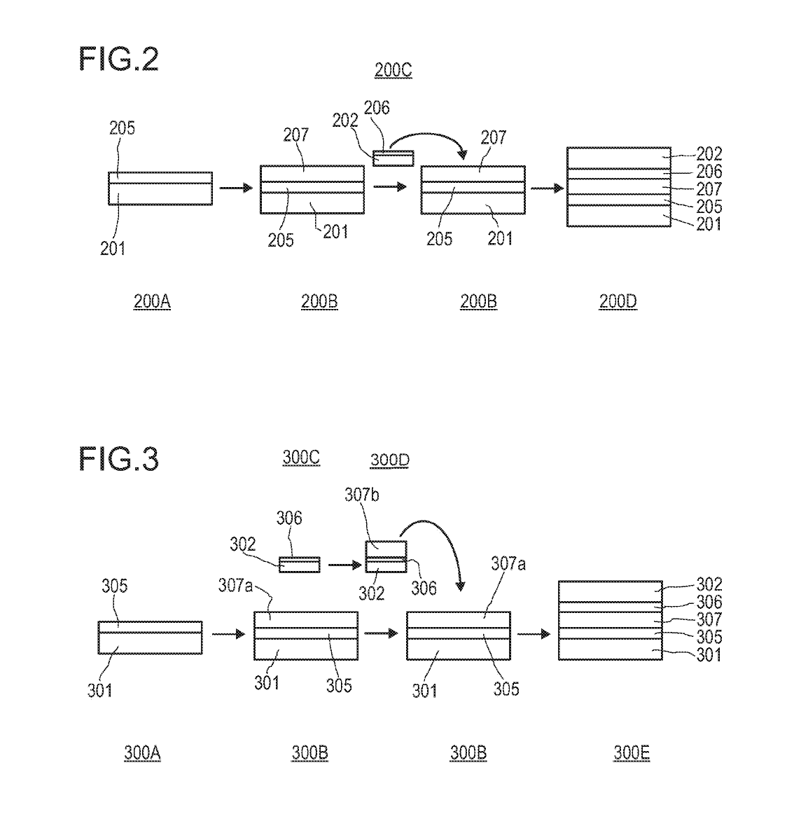

FIG. 2 is a schematic representation of a first alternative of a process according to the third aspect of the present invention

FIG. 3 is a schematic representation of a second alternative of a process according to the third aspect of the present invention

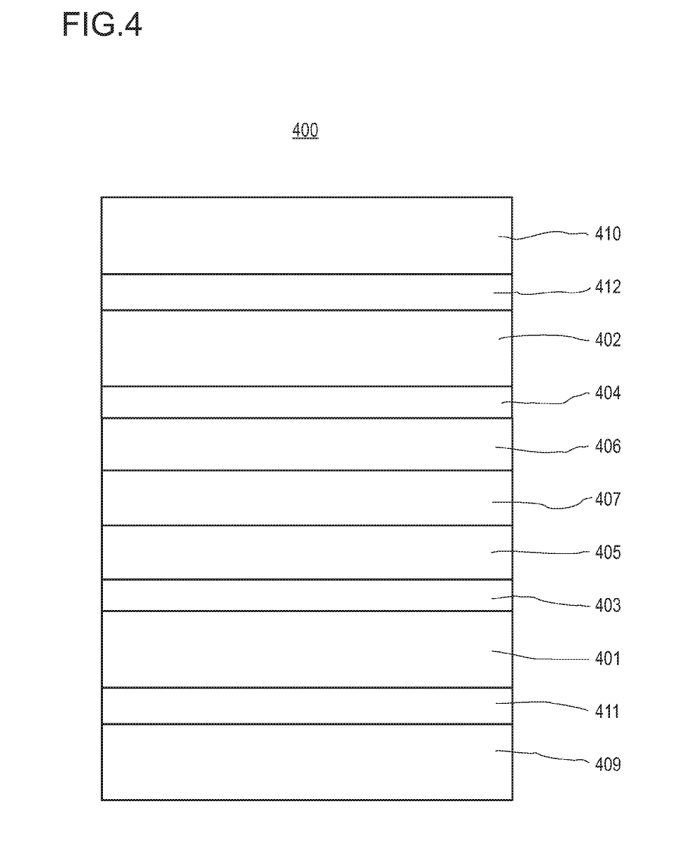

FIG. 4 is a schematic representation of another preferred layer structure obtainable by a process according to a third aspect of the present invention

The layer structure 100 shown in FIG. 1 comprises
a first solid substrate 101 having an electronically conductive surface layer 103
an electrochromic composite layer 105 disposed on said electronically conductive surface layer 103 of said solid substrate 101
an ion-conductive separator layer 107 disposed on the surface of the electrochromic composite layer 105 facing away from the first solid substrate 101
a counter electrode layer 106
a second solid substrate 102 having an electronically conductive surface layer 104 upon which said counter electrode layer 106 is disposed.

The electrochromic composite layer 105 of the layer structure shown in FIG. 1 is prepared as described above and comprises (see enlarged inset on the left side of FIG. 1)
a matrix 105a formed of one or more organic polymers and
dispersed within said matrix 105a:
   nanoobjects comprising one or more electrochromic metal oxides, e.g. nanoparticles 105b consisting of a first electrochromic metal oxide
   electronically conductive nanoobjects which do not comprise metal oxides, e.g. metal nanowires 105c
   at least one electrolyte having cations 105d selected from the group consisting of H⁺, Li⁺, Na⁺ and K⁺, e.g. a lithium salt, dissolved in a solvent (not shown) having a boiling point of 120° C. or higher, wherein said electrolyte comprises at least one anion which is different from OH⁻ or at least one cation from the group consisting of Li⁺, Na⁺ and K⁺.

The ionically conductive separator 107 layer of the layer structure 100 shown in FIG. 1 is prepared as described above and comprises
a matrix 107a formed of one or more organic polymers and
dispersed within said matrix at least one electrolyte having cations 107b selected from the group consisting of H⁺, Li⁺, Na⁺ and K⁺, e.g. a lithium salt, dissolved in a solvent (not shown) having a boiling point of 120° C. or higher

The counter electrode layer 106 of the layer structure 100 shown in FIG. 1 comprises an electroactive material capable of reversibly inserting and releasing ions, e.g. a compound capable of reversibly inserting and releasing lithium ions. Preferably, the counter electrode is a second electrochromic composite layer prepared as described above in the context of the first aspect of the present invention and comprises (not shown in FIG. 1)
a matrix formed of one or more organic polymers and
dispersed within said matrix:
   nanoobjects comprising one or more electrochromic metal oxides different from the electrochromic metal oxides in the first electrochromic composite layer, e.g. nanoparticles consisting of a second electrochromic metal oxide,
   electronically conductive nanoobjects wherein said electronically conductive nanoobjects do not comprise metal oxides, e.g. metal nanowires
   at least one electrolyte having cations selected from the group consisting of H⁺, Li⁺, Na⁺ and K⁺, e.g. a lithium salt, dissolved in a solvent (not shown) having a boiling point of 120° C. or higher, wherein said electrolyte comprises at least one anion which is different from OH⁻ or at least one cation from the group consisting of Li⁺, Na⁺ and K.

The first and second solid substrates 101, 102 are optically transparent. The surface of the first solid substrate layer 101 upon which the electrochromic composite layer 105 is disposed comprises a layer 103 comprising electronically conductive material, preferably an optically transparent electronically conductive material, e.g. indium-tin oxide (ITO). The surface of the second solid substrate layer 102 upon which the counter electrode layer 106 is disposed comprises a layer 104 comprising an electronically conductive material, preferably an optically transparent electronically conductive material, e.g. indium-tin oxide (ITO).

The layers 102 and 104 comprising an electronically conductive material at the surfaces of the solid substrates 101 and 103, resp., can be omitted provided that the electrochromic composite layer 105 and the counter electrode layer 106 have sufficient in-plane conductivity.

A process according to a first preferred alternative of the third aspect of the present invention (as described above) is illustrated in FIG. 2. A preliminary layer structure 200A comprising an electrochromic composite layer 205 (prepared as described above in the context of the first aspect of the present invention) disposed on a surface of a first solid substrate 201 is provided. A first layer structure 200B is obtained by preparing (as described above in the context of the second aspect of the present invention) an ionically conductive separator layer 207 disposed on the surface of the electrochromic composite layer 205 of said preliminary layer structure 200A. Said first layer structure 200B comprises an electrochromic composite layer 205 disposed on a surface of a first solid substrate 201 and an ion-conductive separator layer 207 disposed on the surface of the electrochromic composite layer 205 facing away from the first solid substrate 201.

A second layer structure 200C comprising an electrochromic composite layer 206 disposed on a second substrate 202 (prepared as described above in the context of the first aspect of the present invention) is provided. Said second layer structure 200C does not comprise an ionically conductive separator layer.

Said second layer structure 200C is stacked on top of the ionically conductive separator layer 205 of the first layer structure 200B, so that a resulting layer structure 200D is obtained having said ionically conductive separator layer 207 between the electrochromic composite layer 205 of the first layer structure and the electrochromic composite layer 206 of the second layer structure, and said first and second solid substrates 201, 202 form the lowermost layer and the uppermost layer of said resulting layer structure 200D.

In FIG. 2, merely for the sake of keeping the figure illustrative and clear, second layer structure 200C is drawn smaller relative to layer structures 200A, 200B, 200D. It is however clear for the skilled person that the layer structures to be combined shall have matching surface areas, as shown in resulting layer structure 200D in FIG. 2.

A process according to a second preferred alternative of the third aspect of the present invention (as described above) is illustrated in FIG. 3. A first preliminary layer structure 300A comprising an electrochromic composite layer 305 (prepared as described above in the context of the first aspect of the present invention) disposed on a surface of a first solid substrate 301 is provided. A first layer structure 300B is obtained by preparing (as described above in the context of the second aspect of the present invention) an ionically conductive separator layer 307a disposed on the surface of the electrochromic composite layer 305 of said first preliminary layer structure 300A. Said first layer structure 300B comprises an electrochromic composite layer 305 disposed on a surface of a first solid substrate 301 and an ion-conductive separator layer 307a disposed on the surface of the electrochromic composite layer 305 facing away from the first solid substrate 301.

A second preliminary layer structure 300C comprising an electrochromic composite layer 306 (prepared as described above in the context of the first aspect of the present invention) disposed on a surface of a second solid substrate 302 is provided. A second layer structure 300D is obtained by preparing (as described above in the context of the second aspect of the present invention) an ionically conductive separator layer 307b disposed on the surface of the electrochromic composite layer 306 of said second preliminary layer structure 300C. Said second layer structure 300D comprises an electrochromic composite layer 306 disposed on a surface of a second solid substrate 302 and an ion-conductive separator layer 307b disposed on the surface of the electrochromic composite layer 306 facing away from the second solid substrate 302.

Said second layer structure 300D is stacked on top of the ionically conductive separator layer 307a of the first layer structure 300B, so that a resulting layer structure 300E is obtained having between the electrochromic composite layer 305 of the first layer structure and the electrochromic composite layer 306 of the second layer structure a resulting ionically conductive separator layer 307 which consists of the ionically conductive separator layer 307a of the first layer structure 300B and the ionically conductive separator layer 307b of the second layer structure 300D, and said first and second solid substrates 301, 302 form the lowermost layer and the uppermost layer of said resulting layer structure 300E.

In FIG. 3, merely for the sake of keeping the figure illustrative and clear, layer structures 300C and 300D are drawn smaller relative to layer structures 300A, 300B, 300E. It is however clear for the skilled person that the layer structures to be combined shall have matching surface areas, as shown in resulting layer structure 300E in FIG. 3.

The layer structure 400 shown in FIG. 4 comprises
a first solid substrate 401 having an electronically conductive surface layer 403
an electrochromic composite layer 405 disposed on said electronically conductive surface layer 403 of said solid substrate 401
an ion-conductive separator layer 407 disposed on the surface of the electrochromic composite layer 405 facing away from the first solid substrate 401
a counter electrode layer 406
a second solid substrate 402 having an electronically conductive surface layer 404 upon which said counter electrode layer 406 is disposed.

The layers 403 and 404 comprising an electronically conductive material at the surfaces of the solid substrates 401 and 402, resp., can be omitted provided that the electrochromic composite layer 405 and the counter electrode layer 406 have sufficient in-plane conductivity.

Further in the layer structure according to FIG. 4,
a first support layer 409 is attached to the surface of the first solid substrate 401 facing away from said electrochromic composite layer 405, wherein said first support layer 409 is attached to the first solid substrate 401 by applying an adhesive 411 between the first support layer 409 and the surface of the first solid substrate 401 to which said first support layer 409 has to be attached

and
a second support layer 410 is attached to the surface of the second solid substrate 402 facing away from said counter electrode layer 406, wherein said second support layer 410 is attached to the second solid substrate 402 by applying an adhesive 412 between the second support layer 410 and the surface of the second solid substrate 402 to which said second support layer 410 has to be attached.

Alternatively (not shown in FIG. 4),
a support layer is attached to the surface of the first solid substrate facing away from said electrochromic composite layer and no support layer is attached to the surface of the second solid substrate facing away from said counter electrode layer, or
a support layer is attached to the surface of the second solid substrate facing away from said counter electrode layer, and no support layer is attached to the surface of the first solid substrate facing away from said electrochromic composite layer.

Furthermore, it is preferred that a third support layer (not shown) is attached to the surface of the first support layer 409 facing away from the first solid substrate 401 and/or a fourth support layer is attached to the surface of the second support layer 410 facing away from the second solid substrate 402. In this regard it is particularly preferred that a third support layer is attached to the surface of the first support layer 409 facing away from the first solid substrate 401 and a fourth support layer is attached to the surface of the second support layer 410 facing away from the second solid substrate 402.

1. A process for preparing a layer structure for an electrochromic device,
said process comprising preparing an electrochromic composite layer disposed on a surface of a solid substrate,
wherein preparing said electrochromic composite layer comprises the steps of:
providing a first suspension comprising nanoobjects comprising one or more electrochromic metal oxides dispersed in a first carrier liquid having a boiling point below 120° C.;
providing a second suspension comprising electronically conductive nanoobjects dispersed in a second carrier liquid having a boiling point below 120° C., said electronically conductive nanoobjects not comprising metal oxides;
adding together said first suspension and said second suspension to obtain a third suspension comprising said nanoobjects comprising one or more electrochromic metal oxides and said electronically conductive nanoobjects dispersed in a third carrier liquid having a boiling point below 120° C. consisting of said first carrier liquid and said second carrier liquid;
forming an ink by admixing to said third suspension:
one or more kinds of polymerisable monomers,
optionally one or more initiators for initiating radical polymerization of said one or more kinds of polymerisable monomers,
at least one electrolyte having cations selected from the group consisting of H⁺, Li⁺, Na⁺, K⁺ wherein said at least one electrolyte comprises at least one anion that is different from OH⁻ or at least one cation from the group consisting of Li⁺, Na⁺ and K⁺, an d
a solvent capable of dissolving said at least one electrolyte, wherein said solvent has a boiling point of 120° C. or higher
forming on said surface of said solid substrate a wet film by applying the formed ink to said surface of said solid substrate;
removing said third carrier liquid having a boiling point below 120° C. from the wet film formed on said surface of said solid substrate; and
polymerizing the polymerizable monomers on said surface of said solid substrate.

2. Process according to claim 1, wherein said first carrier liquid and said second carrier liquid have the same or different composition and are selected from the group consisting of water, methanol, ethanol, 1-propanol, 2-propanol, 2-butanol, iso-butanol, acetonitrile and propionitrile and mixtures thereof.

3. Process according to claim 1, wherein said electrochromic metal oxides are selected from the group consisting of oxides of Ti, V, Cr, Mn, Fe, Co, Ni, Nb, Mo, Rh, Ta, W, Ir, Ce and mixtures thereof.

4. Process according to claim 1, wherein said first suspension further comprises
one or more metal salts of formula (I)
(M^{a+})_{z}(R^{b-})_{y} (I),
wherein
M^{a+} represents a metal cation,
R^{b-} represents the corresponding salt anion,
a is 2, 3, 4 or 5,
b is 1, 2 or 3,
z is the least common multiple of a and b, divided by a, and
y is the least common multiple of a and b, divided by b,
wherein at least a portion of said metal salts of formula (I) is physisorbed on the surfaces of said nanoobjects comprising one or more electrochromic metal oxides, and
wherein a molar fraction of metal ions M of said metal salts of formula (I) is in the range of from 0.02 to 6 mol %, based on a total amount of metal in said metal ions M of said metal salts of formula (I) and in said metal oxides in said nanoobjects.

5. Process according to claim 1, wherein said electronically conductive nanoobjects that do not comprise metal oxides are nanowires consisting of materials selected from the group consisting of silver, copper, gold, platinum, tungsten and nickel and alloys of two or more metals selected from the group consisting of silver, copper, gold, platinum, tungsten and nickel, wherein said nanowires have a length in the range of from 1 μm to 100 μm, and a diameter in the range of from 1 nm to 100 nm, length and diameter in each case being determined by transmission electron microscopy.

6. Process according to claim 1, wherein said first suspension, said second suspension, and said third suspension do not contain an electrolyte having cations selected from the group consisting of H⁺, Li⁺, Na⁺and K⁺, which comprises at least one anion which is different from OH⁻ or at least one cation from the group consisting of Li⁺, Na⁺ and K⁺.

7. Process according to claim 1, wherein
in said first suspension the concentration of dispersed nanoobjects comprising one or more electrochromic metal oxides is in the range of from 0.1 wt.-% to 20.0 wt.-%,
and/or
in said second suspension the concentration of dispersed electronically conducting nanoobjects is in the range of from 0.1 wt.-% to 2.0 wt.-%.

8. Process according to claim 1, wherein said first suspension and said second suspension are added together in a volume ratio in the range of from 1:10 to 10:1.

9. Process according to claim 1, wherein
said polymerisable monomers are co-polymerizable monomers selected from the group consisting of alkyl acrylates and alkyl methacrylates and from the group consisting of hydroxyalkyl acrylates and hydroxyalkyl methacrylates,
and/or
said electrolyte is selected from the group consisting of bis(trifluoromethane)sulfonimide, lithium difluorophosphate, lithium hexafluorophosphate, lithium tetrafluroborate, lithium nitrate, lithium bis(flurosulfonyl)imide, lithium bis(trifluoromethane)sulfonimide, lithium trifluoromethane sulfonate, lithium perchlorate, lithium bisoxalatoborate, lithium difluorooxalatoborate, lithium difluorobisoxalatophosphate,
and/or
said solvent having a boiling point of 120° C. or higher is selected from the group consisting of carbonates, alkyl esters of saturated carbonic acids, polyethers, lactones and dinitriles and mixtures thereof.

10. Process according to claim 1, wherein the step of forming said ink comprises admixing a premixture comprising:
one or more kinds of polymerisable monomers,
optionally one or more initiators for initiating radical polymerization of said one or more kinds of polymerisable monomers,
at least one electrolyte having cations selected from the group consisting of H⁺, Li⁺, Na⁺ and K⁺ and anions different from OH⁻, and
a solvent capable of dissolving said electrolytes, wherein said solvent has a boiling point of 120° C. or higher
to said third suspension.

11. Process according to claim 1 wherein the step of forming said ink comprises mechanical agitation of the ink.

12. Process according to claim 1, wherein said ink comprises
said third carrier liquid having a boiling point below 120° C. in an amount of from 42.76 wt.-% to 99.97 wt.-%,
said nanoobjects comprising one or more electrochromic metal oxides in a total amount of from 0.009 wt.-% to 12.53 wt.-%,
said electronically conductive nanoobjects not comprising metal oxides in a total amount of from 0.001 wt.-% to 0.40 wt.-%,
said polymerisable monomers in a total amount of from 0.00006 wt.-% to 40.08 wt.-%,
said initiators for initiating radical polymerization of said polymerisable monomers in a total amount of from 0.000002 wt.-% to 1.05 wt.-%,
said electrolytes having cations selected from the group consisting of H⁺, Li⁺, Na⁺, K⁺ wherein said electrolytes each comprise at least one anion that is different from OH⁻ or at least one cation from the group consisting of Li⁺, Na⁺and K⁺ in a total amount of from 0.001 wt.-% to 1.05 wt.-%, and
said solvent capable of dissolving said electrolytes, wherein said solvent has a boiling point of 120° C. or higher, in an amount of from 0.00003 wt.-% to 6.33 wt.-%
in each case related to the total weight of the ink.

13. Process according to claim 1, wherein
said ink is applied to said surface of said solid substrate by coating or printing,
and/or
said third carrier liquid having a boiling point of less than 120° C. is removed by exposing the wet film formed on said surface of said solid substrate to air having a temperature in the range of from 20° C. to 120° C.,
and/or
said polymerization is initiated by irradiation having a wave length in the range of from 360 nm to 420 nm in the presence of an initiator which decomposes into radicals when exposed to said irradiation.

14. Process according to claim 1,
said process further comprising preparing an ionically conductive separator layer disposed on a surface of said electrochromic composite layer facing away from said solid substrate,
wherein preparing said ionically conductive separator layer comprises the steps of:
forming on said surface of said electrochromic composite layer a wet film by applying to said surface an ink comprising:
one or more kinds of polymerisable monomers,
optionally one or more initiators for initiating radical polymerization of said one or more kinds of polymerisable monomers,
optionally one or more electrolytes having cations selected from the group consisting of H⁺, Li⁺, Na⁺and K⁺,
a solvent capable of dissolving said electrolytes, wherein said solvent has a boiling point of 120° C. or higher, and
optionally a carrier liquid having a boiling point below 120° C.
when said ink contains a carrier liquid having a boiling point below 120° C., removing the carrier liquid having a boiling point below 120° C. from said wet film formed on to said surface of said electrochromic composite layer, and
at least partially polymerizing said polymerizable monomers in said ionically conductive separator layer formed on to said surface of said electrochromic composite layer.

15. Process according to claim 14, wherein said solid substrate comprises a first solid substrate,
said process further comprising applying a counter electrode layer,
wherein applying said counter electrode layer comprises the steps of:
preparing or providing a layer assembly comprising a counter electrode layer disposed on a surface of a second solid substrate and optionally an ion conductive separator layer disposed on the surface of said counter electrode layer facing away from said second solid substrate
stacking said layer assembly on top of said ionically conductive separator layer of a layer structure prepared by the process according to claim 14, such that a resulting layer structure is obtained having an ionically conductive separator layer between an electrochromic composite layer and said counter electrode layer.

16. Process according to claim 15,
said process further comprising attaching a first support layer to said surface of said first solid substrate facing away from said electrochromic composite layer and/or attaching a second support layer to said surface of said second solid substrate facing away from said counter electrode layer, and optionally attaching a third support layer to the surface of said first support layer facing away from said first solid substrate and/or a fourth support layer to said surface of said second support layer facing away from said second solid substrate.

17. Process for manufacturing an electrochromic device, comprising
preparing one or more layer structures according to the process of claim 1, or
providing one or more layer structures manufactured according to the process of claim 1.

18. Process according to claim 5, wherein said nanowires have a diameter in the range of from 10 nm to 50 nm.

19. Process according to claim 18, wherein said nanowires have a diameter in the range of from 15 nm to 30 nm.
